(19) United States
(12) Patent Application Publication
(10) Pub. No.: US 2026/0094750 A1
(43) Pub. Date: Apr. 2, 2026

(54) COIL COMPONENT

(71) Applicant: TDK Corporation, Tokyo (JP)

(72) Inventors: Munehiro TAKAKU, Tokyo (JP); Kazuya TOBITA, Tolyo (JP); Shinnosuke SUZUKI, Tokyo (JP); Tomohiro KAITO, Tokyo (JP)

(73) Assignee: TDK Corporation, Tokyo (JP)

(21) Appl. No.: 19/338,338

(22) Filed: Sep. 24, 2025

(30) Foreign Application Priority Data
Sep. 30, 2024 (JP) 2024-169946

(51) Int. Cl. H01F 5/04; H01F 17/02

(52) U.S. Cl. CPC H01F 5/04; H01F 17/02

(57) ABSTRACT

A coil component disclose includes an element body that is transmissive to visible light, a pair of external conductors on the element body, a coil in the element body, and a pair of internal conductors connecting the coil and the pair of external conductors. The element body includes a pair of end faces, a pair of first side faces, and a pair of second side faces. A length of each of the pair of end faces in a second direction and a length of each of the pair of end faces in the a direction are equal. A surface roughness of one of the pair of second side faces is lower than a surface roughness of at least one of the pair of first side faces. A coil axis of the coil intersects the pair of first side faces.

### CROSS-REFERENCE TO RELATED APPLICATIONS

This application is based upon and claims the benefit of priority from Japanese Patent Application No. 2024-169946, filed on September 30, 2024, the entire contents of which are incorporated herein by reference.

### BACKGROUND

### Field

The present disclose relates to a coil component.

### Description of the Related Art

International Publication No. 2015/016079 discloses a coil component that includes an element body, a pair of external conductors located on the element body, a coil located in the element body, and a pair of internal conductors that connect the coil and the external conductors. The element body has a pair of end faces opposing each other in a first direction, a pair of first side faces opposing each other in a second direction orthogonal to the first direction, and a pair of second side faces opposing each other in a third direction orthogonal to the first direction and the second direction. The coil is located such that a coil axis of the coil intersects the pair of second side faces.

### SUMMARY

It is difficult to determine the orientation of a coil component from its appearance if the first side faces and the second side faces have the same shape. For example, if the orientation of the coil component cannot be confirmed when accommodating the coil component in a carrier tape or when mounting it on an electronic device, a mounting failure may occur.

One aspect of the present disclosure is to provide an coil component that facilitates confirmation of its orientation.

A coil component according to one aspect of the present disclose includes an element body that is transmissive to visible light, a pair of external conductors on the element body, a coil in the element body, and a pair of internal conductors connecting the coil and the pair of external conductors. The element body includes a pair of end faces opposing each other in a first direction, a pair of first side faces opposing each other in a second direction, and a pair of second side faces opposing each other in a third direction. The second direction is orthogonal to the first direction. The third direction is orthogonal to the first direction and the second direction. A length of each of the pair of end faces in the second direction and a length of each of the pair of end faces in the third direction are equal. A surface roughness of one of the pair of second side faces is lower than a surface roughness of at least one of the pair of first side faces. A coil axis of the coil intersects the pair of first side faces.

In the one aspect described above, the second direction and the third direction are orthogonal to each other, and the second direction and the third direction are each orthogonal to the first direction. Therefore, a length of each of the pair of first side faces opposing each other in the second direction in the first direction and a length of each of the pair of second side faces opposing each other in the third direction in the first direction are equal.

Since the first direction and the second direction are orthogonal to each other, and the first direction and the second direction are each orthogonal to the third direction, a length of each of the pair of end faces in the third direction and a length of each of the pair of first side faces in the third direction are equal.

Since the first direction and the third direction are orthogonal to each other, and the first direction and the third direction are each orthogonal to the second direction, a length of each of the pair of end faces in the second direction and a length of each of the pair of second side faces in the second direction are equal.

Therefore, the length of each of the end faces and the first side faces in the third direction is equal, and the length of each of the end faces and the second side faces in the second direction is equal. As a result, in a configuration where the length of each of the pair of end faces in the second direction and the length of each of the pair of end faces in the third direction are equal, the length of the first side faces in the third direction and the length of the second side faces in the second direction are equal. Since the length of each edge defining the first side face and the length of each edge defining the second side face are equal, the first side faces and the second side faces have the same shape.

The coil has a spiral shape centered on the coil axis. In the one aspect described above, since the coil axis intersects the pair of first side faces, each part of the coil having the spiral shape is adjacent to the pair of end faces and the pair of second side faces, respectively. A space at the center of the spiral shape of the coil is not adjacent to the second side faces. The element body is transmissive to visible light, and the surface roughness of one of the pair of second side faces is lower than the surface roughness of at least one of the pair of first side faces. The surface roughness of the one of the second side faces is low, and the space at the center of the spiral shape of the coil is not visible from the second side faces. Therefore, the coil in the element body that is transmissive to visible light is easily confirmed from the one of the second side faces.

As a result, even if the first side faces and the second side faces have the same shape, the coil component facilitates confirmation of its orientation because the coil in the element body can be confirmed from the second side faces.

### BRIEF DESCRIPTION OF THE DRAWINGS

FIG. 1 is a perspective view of a coil component according to an embodiment;

FIG. 2 is a side view of the coil component according to the present embodiment as viewed from one side face;

FIG. 3 is a end view of the coil component according to the present embodiment as viewed from one end face; and

FIG. 4 is a side view of the coil component according to the present embodiment as viewed from another side face.

### DETAILED DESCRIPTION

Hereinafter, examples of the present disclosure will be described in detail with reference to the accompanying drawings. In the following description, the same components or components having the same functions are denoted with the same reference numerals and overlapped explanation is omitted.

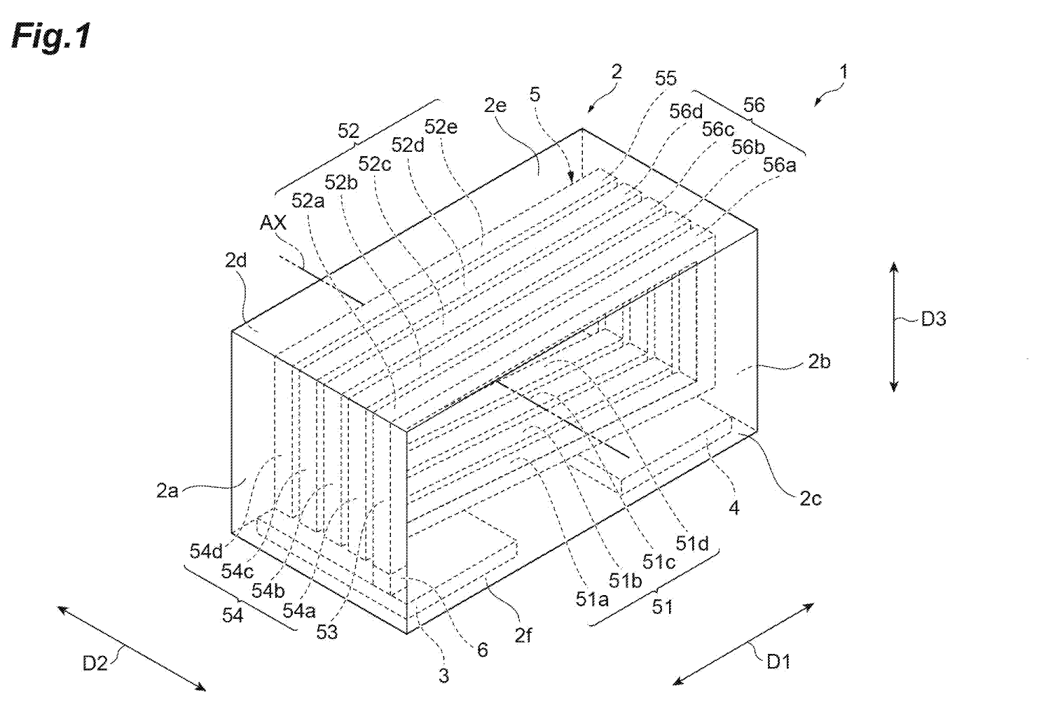

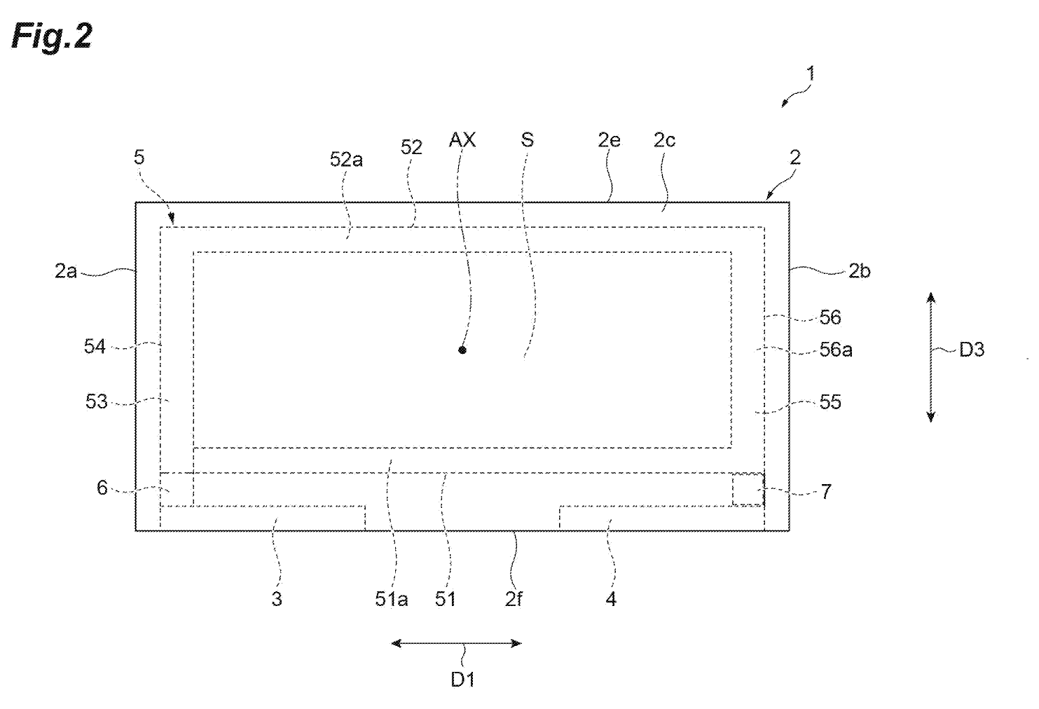

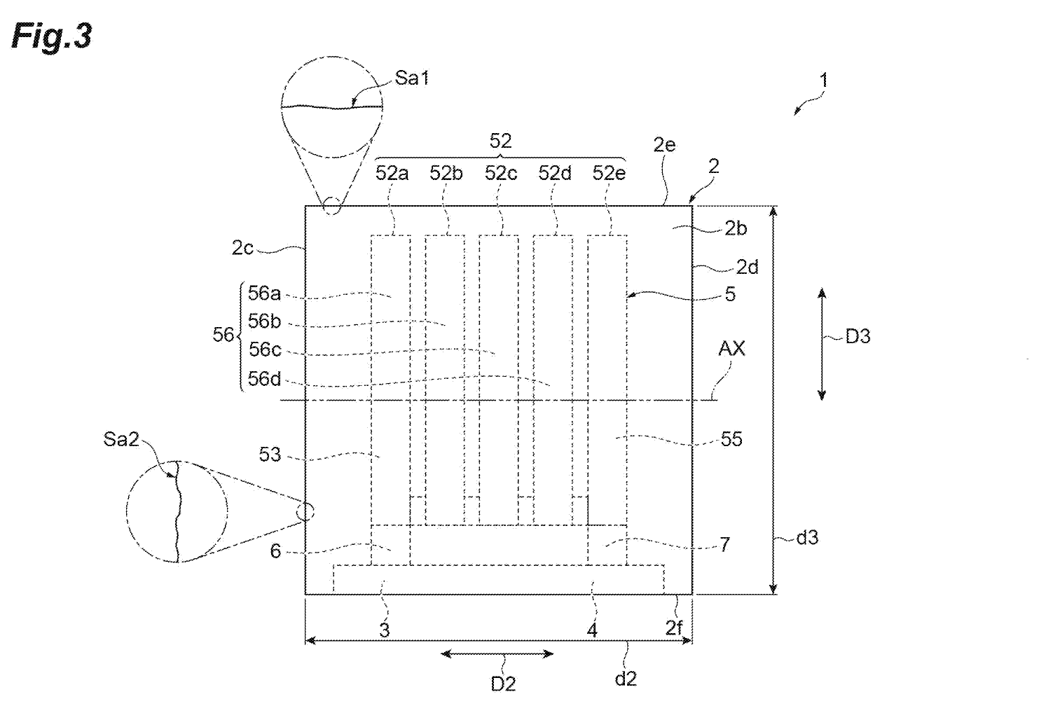

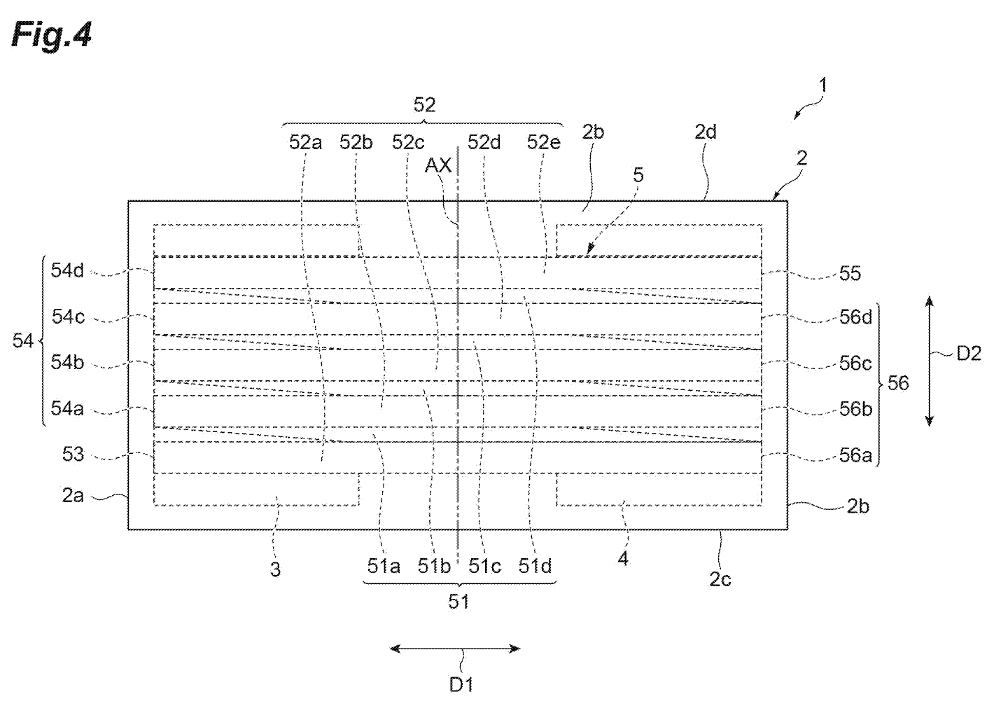

The configuration of a coil component 1 according to the present embodiment will be described with reference to FIG. 1 to FIG.4. FIG. 1 is a perspective view of the coil component according to the present embodiment. FIG. 2 is a side view of the coil component according to the present embodiment as viewed from a side face 2c shown in FIG. 1. FIG. 3 is a end view of the coil component according to the present embodiment as viewed from an end face 2b shown in FIG. 1. FIG. 4 is a side view of the coil according to the present embodiment as viewed from a side face 2e shown in FIG. 1. The coil component 1 according to the present embodiment is solder-mounted on an electronic device. The electronic device includes, for example, a circuit board or an electronic component. As shown in FIG. 1 to FIG.4, the coil component 1 includes an element body 2, an external conductor 3, an external conductor 4, a coil 5, an internal conductor 6, and an internal conductor 7.

The element body 2 has a rectangular parallelepiped shape. The rectangular parallelepiped shape includes a shape of a rectangular parallelepiped in which corners and ridge portions are chamfered and rounded. The element body 2 includes an end face 2a and an end face 2b opposing each other, a side face 2c and a side face 2d opposing each other, and a side face 2e and a side face 2f opposing each other. The side face 2c and the side face 2d and the side face 2e and the side face 2f connect the end face 2a and the end face 2b. The side face 2c and the side face 2d and the side face 2e and the side face 2f are adjacent to each other via corners or ridge portions. The pair of end face 2a and end face 2b oppose each other in a direction D1. The pair of side faces 2c and 2d oppose each other in a direction D2. The pair of side faces 2e and 2f oppose each other in a direction D3. The direction D2 is orthogonal to the direction D1. The direction D3 is orthogonal to the direction D1 and the direction D2.

For example, the direction D1 includes a first direction, the direction D2 includes a second direction, and the direction D3 includes a third direction. For example, the pair of side faces 2c and 2d includes a pair of first side faces, and the pair of side faces 2e and 2f includes a pair of second side faces.

Referring to FIG. 3, a length d2 of each of the pair of end faces 2a, 2b in the direction D2 and a length d3 of each of the pair of end faces 2a, 2b in the direction D3 are equal. The term "equal" includes not only being identical but also values that may have a slight difference within a preset range or a manufacturing variation. For example, if a difference between the length d2 and the length d3 is within a range of ±5% of the length d2 or the length d3, the length d2 and the length d3 are defined as being equal. In one example, the difference between the length of each of the pair of end faces 2a, 2b in the direction D2 and the length of each of the pair of end faces 2a, 2b in the direction D3 is 20 μm or less. The end faces 2a, 2b each have a square shape. The length of each of the side face 2c and the side face 2d in the direction D3 and the length of each of the side face 2e and the side face 2f in the direction D2 are equal. The length of each of the side face 2c and the side face 2d in the direction D1 and the length of each of the side face 2e and the side face 2f in the direction D1 are equal. Each of the side faces 2c, 2d, 2e, and 2f may have a rectangular shape with a side along the direction D1 as a long side. Since the length of each edge defining each of the side faces 2c and 2d is equal to the length of each edge defining each of the side faces 2e and 2f, the side faces 2c, 2d, 2e, and 2f are have the same shape.

The element body 2 includes a plurality of insulator layers having electrical insulation properties. In the present embodiment, the element body 2 includes a plurality of insulator layers laminated along the direction D3. In an actual element body 2, the plurality of insulator layers are integrated to such an extent that their boundaries are not visible. Each of the plurality of insulator layers has, for example, a rectangular shape when viewed from the direction D3. The insulator layer may include a non-magnetic material. The non-magnetic material includes, for example, a glass ceramic material or a dielectric material. The insulator layer may include a resin material. The resin material includes, for example, at least one selected from the group consisting of liquid crystal polymer, polyimide resin, crystalline polystyrene, epoxy-based resin, acrylic-based resin, bismaleimide-based resin, and fluorine-based resin. The resin material includes, for example, a filler. The filler includes, for example, an inorganic filler. The inorganic filler includes silica. The resin material may not include a filler.

The element body 2 is transmissive to visible light. In one example, the element body 2 may be translucent. The total light transmittance of the element body 2 is higher than 0%. For example, the total light transmittance of the element body 2 is 20% or more. Referring to FIG. 3, a surface roughness Sa1 of the side face 2e is lower than a surface roughness Sa2 of at least one of the pair of side faces 2c, 2d. In the present embodiment, the surface roughness Sa1 of the side face 2e is lower than the surface roughness of each of the pair of side faces 2c, 2d. In the present embodiment, the surface roughness Sa1 of the side face 2e is 0.4 μm or less. In one example, the surface roughness Sa1 of the side face 2e is 0.4 μm or less and 0.01 μm or more. The surface roughness may include an arithmetic mean height Sa. The arithmetic mean height Sa of the side face 2e may be 0.4 μm or less and 0.01 μm or more. For example, the side face 2e includes one of the pair of second side faces.

The pair of external conductors 3 and 4 are located on the element body 2. In the present embodiment, the pair of external conductors 3 and 4 are located on the side face 2f. When the coil component 1 is solder-mounted on an electronic device, the external conductors 3 and 4 are connected to terminals of the electronic device. For example, the side face 2f includes the other of the pair of second side faces. When the coil component 1 is solder-mounted on an electronic device, the side face 2f faces the electronic device on which it is to be solder-mounted.

The external conductors 3 and 4 are arranged apart in the direction D1. The external conductor 3 is located near the end face 2a, and the external conductor 4 is located near the end face 2b. In the present embodiment, the pair of external conductors 3 and 4 are located only on the side face 2f. The external conductors 3 and 4 are respectively located in a pair of depressions formed in the side face 2f. When viewed from the direction D3, the external conductors 3 and 4 are spaced apart from an outer edge of the side face 2f. When viewed from the direction D3, the external conductors 3 and 4 have a rectangular shape. The external conductors 3 and 4 have a long edge along the direction D2 and a short edge along the direction D1.

The external conductors 3 and 4 include a conductive material. The conductive material includes, for example, Ag, Pd, Cu, or Al. The conductive material includes, for example, an Ag-Pd alloy, an Ag-Cu alloy, an Ag-Au alloy, or an Ag-Pt alloy. The external conductors 3 and 4 include, for example, a Ni plating film, an Sn plating film, a Cu plating film, or an Au plating film. The external conductors 3 and 4 may have a multilayer structure of the plating films described above, and may include a Ni plating film and an Sn plating film formed on the Ni plating film. The plating film is formed by, for example, an electrolytic plating method or an electroless plating method.

The coil 5 is located in the element body 2. A coil axis AX of the coil 5 intersects the pair of side faces 2c and 2d. For example, the coil axis AX is the central axis of the coil 5 and has infinite length. In the present embodiment, the coil axis AX of the coil 5 is along the direction D2. The coil 5 has a spiral shape centered on the coil axis AX. The coil 5 has a plurality of coil conductors located so as to have a spiral shape centered on the coil axis AX. The coil 5 has at least one coil conductor 51, at least one coil conductor 52, a coil conductor 53, at least one coil conductor 54, a coil conductor 55, and at least one coil conductor 56. As shown in FIG. 3, when viewed from the direction D2, the coil 5 has a rectangular shape. The coil 5 includes the conductive material described above. The coil 5, the internal conductor 6 and the internal conductor 7, and the external conductor 3 and the external conductor 4 are electrically connected.

The at least one coil conductor 51 is adjacent to the side face 2f. The at least one coil conductor 51 includes a conductor 51a, a conductor 51b, a conductor 51c, and a conductor 51d. The conductors 51a, 51b, 51c, and 51d extend along the direction D1. The conductors 51a, 51b, 51c, and 51d are arranged in the direction D2. The conductor 51a is located at an end close to the side face 2c in the direction D2, and the conductor 51d is located at an end close to the side face 2d in the direction D2.

The at least one coil conductor 52 is adjacent to the side face 2e. The at least one coil conductor 52 includes a plurality of conductors. The at least one coil conductor 52 includes a conductor 52a, a conductor 52b, a conductor 52c, a conductor 52d, and a conductor 52e. The conductors 52a, 52b, 52c, 52d, and 52e each extend along the direction D1. The conductors 52a, 52b, 52c, 52d, and 52e are arranged in the direction D2. The conductor 52a is located at an end close to the side face 2c in the direction D2, and the conductor 52e is located at an end close to the side face 2d in the direction D2.

The coil conductor 53 connects the conductor 52a and the internal conductor 6. The coil conductor 53 is connected to the external conductor 3 via the internal conductor 6. The coil conductor 53 is adjacent to the end face 2a. The coil conductor 53 extends along the direction D3. In the coil 5, the coil conductor 53 is located at an end close to the side face 2c in the direction D2.

The coil conductor 55 connects the conductor 52e and the internal conductor 7. The coil conductor 55 is connected to the external conductor 4 via the internal conductor 7. The coil conductor 55 is adjacent to the end face 2b. The coil conductor 55 extends along the direction D3. In the coil 5, the coil conductor 55 is located at an end close to the side face 2d in the direction D2.

The at least one coil conductor 54 connects the at least one coil conductor 51 and the at least one coil conductor 52. The at least one coil conductor 54 is adjacent to the end face 2a. The at least one coil conductor 54 includes a conductor 54a, a conductor 54b, a conductor 54c, and a conductor 54d. As shown in FIG. 5, a shortest distance between the conductors 54a, 54b, 54c, 54d and the end face 2a and a shortest distance between the external conductor 3 and the end face 2a may be equal to each other. The conductors 54a, 54b, 54c, and 54d extend along the direction D3. The conductors 54a, 54b, 54c, and 54d are arranged in the direction D2. The conductor 54d is located at an end close to the side face 2d. The conductor 54a is adjacent to the coil conductor 53 in the direction D2.

The at least one coil conductor 56 connects the at least one coil conductor 51 and the at least one coil conductor 52. The at least one coil conductor 56 is adjacent to the end face 2b. The at least one coil conductor 56 includes a conductor 56a, a conductor 56b, a conductor 56c, and a conductor 56d. As shown in FIG. 5, a shortest distance between the conductors 56a, 56b, 56c, 56d and the end face 2b and a shortest distance between the external conductor 4 and the end face 2b may be equal to each other. The conductors 56a, 56b, 56c, and 56d extend along the direction D3. The conductors 56a, 56b, 56c, and 56d are arranged in the direction D2. The conductor 56a is located at an end close to the side face 2c. The conductor 56d is adjacent to the coil conductor 55 in the direction D2.

The coil conductor 53 connects the internal conductor 6 and the conductor 52a. The conductor 56a connects the conductor 52a and the conductor 51a. The conductor 54a connects the conductor 51a and the conductor 52b. The conductor 56b connects the conductor 52b and the conductor 51b. The conductor 54b connects the conductor 51b and the conductor 52c. The conductor 56c connects the conductor 52c and the conductor 51c. The conductor 54c connects the conductor 51c and the conductor 52d. The conductor 56d connects the conductor 52d and the conductor 51d. The conductor 54d connects the conductor 51d and the conductor 52e. The coil conductor 55 connects the conductor 52e and the internal conductor 7.

A shortest distance between the side face 2e and the coil 5 is shorter than a shortest distance between at least one of the pair of side faces 2c and 2d and the coil 5. As shown in FIG. 3, the shortest distance between the side face 2e and the coil 5 may be shorter than a shortest distance between each of the pair of side faces 2c and 2d and the coil 5. The shortest distance between the side face 2e and the coil 5 is shorter than a shortest distance between the side face 2f and the coil 5. In one example, the shortest distance between the side face 2e and the coil 5 is 25 μm or less.

As shown in FIG. 3, the coil 5 defines a space S at the center of the spiral shape. The coil axis AX of the coil 5 passes through the space S. The space S is located at the center of the coil component 1 when viewed from the side faces 2c, 2d. In the coil component 1, a part of the element body 2 is located in a region within the space S.

The pair of internal conductors 6 and 7 connect the pair of external conductors 3 and 4 to the coil 5. The internal conductor 6 is located between the external conductor 3 and the coil 5 in the direction D3. Specifically, the internal conductor 6 is located between the external conductor 3 and the coil conductor 53 of the coil 5 in the direction D3. The internal conductor 6 connects the external conductor 3 and the coil conductor 53 of the coil 5. In the actual coil component 1, the coil conductor 53 and the internal conductor 6 are integrated to such an extent that their boundary is not visible. The internal conductor 7 is located between the external conductor 4 and the coil 5 in the direction D3. Specifically, the internal conductor 7 is located between the external conductor 4 and the coil conductor 55 of the coil 5 in the direction D3. The internal conductor 7 connects the external conductor 4 and the coil conductor 55 of the coil 5. In the actual coil component 1, the coil conductor 55 and the internal conductor 7 are integrated to such an extent that their boundary is not visible.

As described above, a length of each of the pair of side faces 2c and 2d opposing each other in the direction D2 in the direction D1 and a length of each of the pair of side faces 2e, 2f opposing each other in the direction D3 in the direction D1 are equal. A length of each of the pair of end faces 2a and 2b opposing each other in the direction D1 in the direction D3 and a length of each of the pair of side faces 2c and 2d opposing each other in the direction D2 in the direction D3 are equal. A length of each of the pair of end faces 2a and 2b opposing each other in the direction D1 in the direction D2 and a length of each of the pair of side faces 2e, 2f opposing each other in the direction D3 in the direction D2 are equal.

Therefore, the length of each of the end faces 2a and 2b and the side faces 2c and 2d in the direction D3 is equal, and the length of each of the end faces 2a and 2b and the side faces 2e and 2f in the direction D2 is equal. As a result, in a configuration where the length d2 of each of the pair of end faces 2a and 2b opposing each other in the direction D3 in the direction D2 and the length d3 of each of the pair of end faces 2a and 2b opposing each other in the direction D3 in the direction D3 are equal, the length of the side faces 2c and 2d in the direction D3 and the length of the side faces 2e and 2f in the direction D2 are equal. Since the length of each side defining the side faces 2c and 2d is equal to the length of each side defining the side faces 2e and 2f, the side faces 2c, 2d, 2e, and 2f have the same shape.

The surface roughness of the side face 2e is low, and the space S at the center of the spiral shape of the coil 5 is not visible from the side faces 2e, 2f. Therefore, since the coil conductor 52 of the coil 5 is reliably located at the center of the coil component 1 when viewed from the side face 2e, the coil 5 is easily confirmed from the side face 2e.

For example, a central region of the coil component 1 when viewed from the side face 2e may be darker than a central region of the coil component 1 when viewed from the side face 2c or the side face 2d. The surface roughness of the side face 2e is low, and since the coil conductor 52 of the coil 5 is reliably located at the center of the coil component 1 when viewed from the side face 2e, a shadow of the coil 5 appears in the central region when viewed from the side face 2d. A grayscale value of the central region of the coil component 1 when viewed from the side face 2e may be lower than a grayscale value of the central region of the coil component 1 when viewed from the side face 2c or the side face 2d.

As a result, even if the side faces 2c, 2d, 2e, and 2f have the same shape, the coil 5 in the element body 2 is confirmed from the side face 2e, so that the coil component 1 facilitates confirmation of its orientation.

The shortest distance between the side face 2e and the coil 5 is shorter than the shortest distance between at least one of the pair of side faces 2c and 2d and the coil 5.

In a configuration where the shortest distance between the side face 2e and the coil 5 is shorter than the shortest distance between at least one of the pair of side faces 2c, 2d and the coil 5, the coil 5 is even more easily confirmed when the coil component 1 is viewed from the side face 2e than when it is viewed from the side face 2c or the side face 2d.

The present disclose has been described in detail above based on its embodiments. However, the present disclose is not limited to the above-described embodiments. The present disclose can be modified in various ways without departing from the gist thereof.

The external conductors 3 and 4 may be located on the end faces 2a and 2b, respectively. The external conductor 3 may be exposed from the side face 2e and exposed from the end face 2a. The external conductor 4 may be exposed from the side face 2e and exposed from the end face 2b. The external conductors 3 and 4 may have an L-shape when viewed from the direction D2. The external conductors 3 and 4 may be located on one of the side faces 2c and 2d.

The central region of the coil component 1 when viewed from the side face 2e may be darker than an outer edge region of the coil component 1 when viewed from the side face 2e. A grayscale value of the central region of the coil component 1 when viewed from the side face 2e may be smaller than a grayscale value of the outer edge region of the coil component 1 when viewed from the side face 2e.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A coil component comprising:
an element body that is transmissive to visible light and includes a pair of end faces opposing each other in a first direction, a pair of first side faces opposing each other in a second direction orthogonal to the first direction, and a pair of second side faces opposing each other in a third direction orthogonal to the first direction and the second direction;
a pair of external conductors on the element body;
a coil in the element body; and
a pair of internal conductors connecting the pair of external conductors and the coil,
wherein a length of each of the pair of end faces in the second direction and a length of each of the pair of end faces in the third direction are equal,
a surface roughness of one of the pair of second side faces is lower than a surface roughness of at least one of the pair of first side faces, and
a coil axis of the coil intersects the pair of first side faces.

2. The coil component according to claim 1, wherein
the pair of external conductors are located on the other of the pair of second side faces.

3. The coil component according to claim 2, wherein
the pair of external conductors are located only on the other of the pair of second side faces.

4. The coil component according to claim 1, wherein
a shortest distance between the one of the pair of second side faces and the coil is shorter than a shortest distance between at least one of the pair of first side faces and the coil.

5. The coil component according to claim 1, wherein
the surface roughness of the one of the pair of second side faces is lower than a surface roughness of each of the pair of first side faces.

6. The coil component according to claim 1, wherein
the surface roughness of the one of the pair of second side faces is 0.4 μm or less.

7. The coil component according to claim 1, wherein
a shortest distance between the one of the pair of second side faces and the coil is 25 μm or less.
